(19) United States
(12) Patent Application Publication
(10) Pub. No.: US 2014/0063045 A1
(43) Pub. Date: Mar. 6, 2014

(54) DEVICE AND METHOD FOR DISPLAYING AND ADJUSTING IMAGE INFORMATION

(71) Applicant: WISTRON CORPORATION, New Taipei City (TW)

(72) Inventor: Yao-Tsung Chang, New Taipei City (TW)

(73) Assignee: Wistron Corporation, New Taipei City (TW)

(21) Appl. No.: 13/875,319

(22) Filed: May 2, 2013

(30) Foreign Application Priority Data
Aug. 28, 2012 (TW) 101131209

(51) Int. Cl. G09G 5/10; G09G 3/32; G09G 3/36

(52) U.S. Cl. CPC G09G 5/10; G09G 3/36; G09G 3/3208
USPC 345/592

(57) ABSTRACT

A device and a method for displaying and adjusting image information are disclosed. The method at least includes steps of: controlling an LCD unit to be transparent, so that an environmental scene is visible, and an image information is displayed on the LCD unit according to a display instruction; executing a first automatic adjustment procedure. The first automatic adjustment procedure includes steps of: detecting the light intensity of the environment by the light-detecting unit to correspondingly generate a first detection value; comparing the first detection value with a determination range of light intensity by the processor to generate an automatic adjustment instruction according to the operation status of the active light source module; automatically adjusting the operation status of the active light source module according to the automatic adjustment instruction to adjust the brightness of the image information and correspondingly adjust the transparency of the LCD unit.

This application claims the benefit of Taiwan application Serial No. 101131209, filed Aug. 28, 2012, the subject matter of which is incorporated herein by reference.

### BACKGROUND OF THE INVENTION

1. Field of the Invention

The invention relates in general to a device and a method for displaying and adjusting image information, and more particularly to a display device, which controls the operation status of the active light source module to adjust the brightness of the displayed image information and controls the crystalline molecules of the liquid crystal panel to adjust the transparency of the displayed image through the design of an automatic adjustment procedure and a user manual adjustment procedure, and a method using the same.

2. Description of the Related Art

The glasses type or headset device with projection function currently available in the market is capable of projecting relevant information to the front of the user's eyes. Such device can be designed in the architecture of wearable glasses, and a relevant projection unit (such as a scanning laser unit) and an operation interface can be disposed near the glasses frame, such that the user can operate the operation interface and project corresponding image information to the glasses lens with the projection unit. An image information display device in the architecture of glasses is disclosed in the U.S. Pat. No. 8,203,502 “Wearable Heads-Up Display With Integrated Finger-Tracking Input Sensor”.

Based on the operation of the image information display device, current technology can further provide a projection or display unit capable of displaying corresponding image information as an image information display device in the form of a single body. The image information display device, which can be disposed or hanged on the user's glasses, displays image information for the user to view. In other words, the said image information display device can be used in ordinary glasses, that is, the said image information display device can be disposed or hanged on an ordinary headset frame at a position near the eyes for projecting image information to the front of the user's eyes.

According to the current manufacturing technology, the liquid crystal panel of the liquid crystal display (LCD) is formed by a transparent material, such that the liquid crystal panel can be used as the lens of the image information display device. When the crystalline molecules arranged in the form of an array are collocated with the use of polarizer, the image combination between the bright/dark status and between corresponding colors makes image information, such as texts and symbols, displayed on the liquid crystal panel. Meanwhile, other regions of the liquid crystal panel still remain transparent, such that the user can see the environmental scene in front of the panel.

The said image information display device provides additional image information so that the user in movement can receive more reference or execute other applications such as searching, inquiring and browsing. Examples of image information include the current time, the local temperature, the same day schedule, mails, the route guide and the use of the Internet. The user can directly operate the said image information display device through an operation interface or wirelessly operate the said image information display device with a remote controller by way of wireless signal transmission.

As disclosed above, the lens of the said image information display device (such as glass or liquid crystal panel) on which image information is projected or displayed is formed by a transparent material. The image information can be presented in the form of texts, patterns or symbols, and only occupies a small part of the lens, and the other part of the lens still remain transparent so that the user can see the environmental scene in front of the lens. Alternatively, parameters, such as color and contrast, make the displayed texts or symbols partially permeable to the light. That is, the said image information display device when worn on or used by the user will not impede the user's vision or action.

Since the lens or liquid crystal panel is formed by a transparent material, the visual effect of the image information displayed thereon is susceptible to the change in environmental brightness. Since the user when using the said image information display device is normally in movement, the environmental brightness is changeable. Let the image information display device formed by liquid crystal panel be taken for example. Given that the image display of the transparent liquid crystal panel uses the ambient light as the main backlight source and the lens must be transmissive, the active light source module used for enhancing illumination must be side type. Therefore, the display on the liquid crystal panel will correspond to the intensity of the ambient light. That is, the displayed image information will become relatively brighter when the ambient light turns brighter, and the displayed image information will become relatively darker when the ambient light turns darker. Therefore, the environmental brightness, no matter being too bright or too dark, will affect the user's viewing image information, or cause visual discomfort to the user and affect the user's safety in movement.

### SUMMARY OF THE INVENTION

The invention is directed to a device and a method for displaying and adjusting image information. The operation status of the active light source module is controlled through the design of an automatic adjustment procedure to adjust the brightness of the displayed image information and control the crystalline molecules of a liquid crystal panel to adjust the transparency levels of the environmental scene and the displayed image information. By doing so, the user may have appropriate visual conditions no matter when viewing an environmental scene or an image information. The device of the invention may further be equipped with the design of manual adjustment so that the adjustment results can better meet the user's needs.

According to an embodiment of the present invention, a method for displaying and adjusting image information is disclosed. The method is used in an image information display device which comprises a light-detecting unit, an LCD unit, an active light source module and a processor. The method at least includes steps of: controlling an LCD unit to be transparent, so that an environmental scene is visible, and an image information is displayed on the LCD unit according to a display instruction; executing a first automatic adjustment procedure, including steps of: detecting the light intensity of the environment by the light-detecting unit to correspondingly generate a first detection value; comparing the first detection value with a determination range of light intensity by the processor to correspondingly generate an automatic adjustment instruction according to the operation status of the active light source module; and automatically adjusting the operation status of the active light source module to adjust the brightness of the image information according to the automatic adjustment instruction and correspondingly adjust the transparency of the LCD unit.

According to another embodiment of the present invention, an image information display device is disclosed. The device comprises an LCD unit, a light-detecting unit, an active light source module, a memory unit, and a processor. The LCD unit is used for controlling to be transparent, so that an environmental scene is visible, and an image information is displayed on the LCD unit according to a display instruction. The light-detecting unit is used for detecting the light intensity of the environment to correspondingly generate a first detection value. The active light source module is used for providing a light source to correspondingly adjust the brightness of the image information. The memory unit is used for storing the image information and a determination range of light intensity. The processor is used for comparing the first detection value with the determination range of light intensity to correspondingly generate an automatic adjustment instruction according to the operation status of the active light source module. The automatic adjustment instruction makes the active light source module automatically adjust its operation status and makes the LCD unit automatically adjust its transparency.

According to an alternate embodiment of the present invention, a method for displaying and adjusting image information is disclosed. The method is used in an image information display device which comprises a light-detecting unit, an OLED display unit and a processor. The method at least includes steps of: controlling an OLED display unit to be transparent, so that an environmental scene is visible, and an image information is displayed on the OLED display unit according to a display instruction; detecting the light intensity of the environment by the light-detecting unit to correspondingly generate a detection value; comparing the detection value with a determination range of light intensity and generating a corresponding automatic adjustment instruction by the processor; and automatically adjusting the brightness of the image information displayed on the OLED display unit according to the automatic adjustment instruction.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1(a) shows an appearance diagram of an image information display device 100 of the present invention;

FIG. 1(b) shows a functional block diagram of an image information display device 100;

FIG. 2(a) shows a schematic diagram of an image displayed on the LCD unit 12 in an ordinary light intensity status;

FIG. 2(b) shows a schematic diagram of transparency levels of an environmental scene P1 and an image information P2 displayed on the LCD unit 12 in an ordinary light intensity status;

FIG. 3 shows a flowchart of a first automatic adjustment procedure of present invention;

FIG. 4(a) shows a schematic diagram of an unadjusted image displayed on the LCD unit 12 when the light intensity of an ambient light is in a relatively darker status;

FIG. 4(b) shows a schematic diagram of an adjusted image displayed on the LCD unit 12 when the light intensity of an ambient light is in a relatively darker status;

FIG. 4(c) shows a schematic diagram of transparency levels of an adjusted environmental scene P1 and an adjusted image information P2 displayed on the LCD unit 12;

FIG. 5 (a) shows a schematic diagram of an unadjusted image displayed on the LCD unit 12 when the light intensity of an ambient light is in a relatively even darker status;

FIG. 5 (b) shows a schematic diagram of an adjusted image displayed on the LCD unit 12 when the light intensity of an ambient light is in a relatively even darker status;

FIG. 5 (c) shows a schematic diagram of transparency levels of an adjusted environmental scene P1 and an adjusted image information P2 displayed on the LCD unit 12;

FIG. 6(a) shows a schematic diagram of an unadjusted image displayed on the LCD unit 12 when the light intensity of an ambient light is in a relatively brighter status;

FIG. 6(b) shows a schematic diagram of an adjusted image displayed on the LCD unit 12 when the light intensity of an ambient light is in a relatively brighter status;

FIG. 6(c) shows a schematic diagram of transparency levels of an adjusted environmental scene P1 and an adjusted image information P2 displayed on the LCD unit 12;

FIG. 7(a) shows a flowchart of a manual adjustment procedure of the present invention;

FIG. 7(b) shows a flowchart of a second automatic adjustment procedure of the present invention; and

FIG. 8 shows an example of a contrast reference table completed according to a manual adjustment procedure.

### DETAILED DESCRIPTION OF THE INVENTION

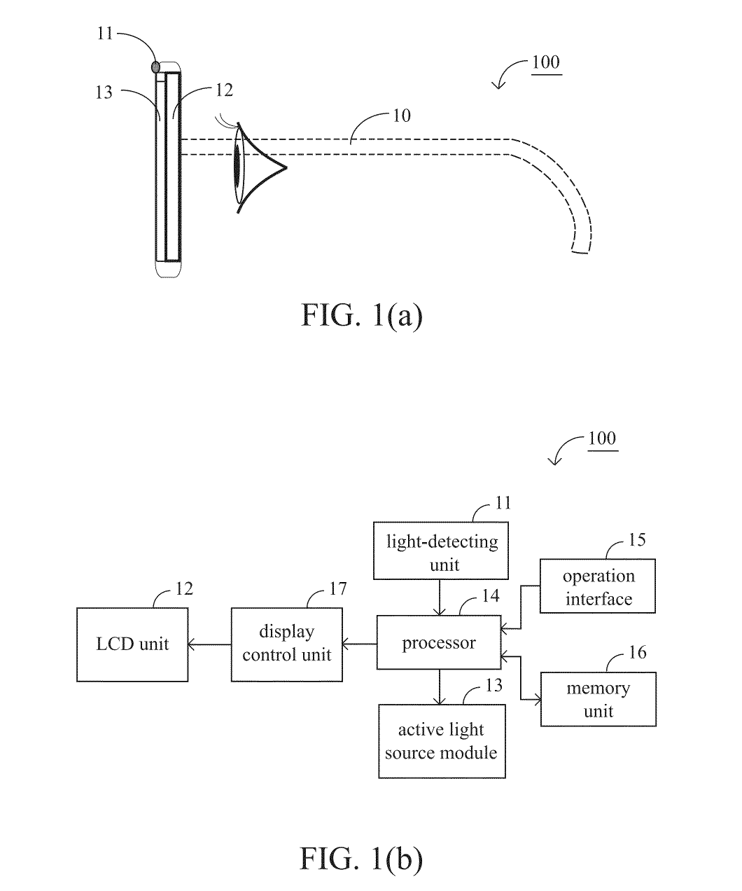

A first embodiment is disclosed below for elaborating the present invention. Referring to FIG. 1(a), an appearance diagram of an image information display device 100 of the present invention is shown. As indicated in the diagram, the architecture of the image information display device 100 is formed by the spectacle frame 10 and can be worn by the user. The image information display device 100 mainly comprises a light-detecting unit 11, an LCD unit 12 and an active light source module 13. In the present embodiment, the lens of the LCD unit 12 is formed by the transparent liquid crystal panel and is located in front of the user's eyes, such that the user may see the environmental scene in front of the panel as well as relevant information displayed on the panel.

As disclosed above, the active light source module 13 is disposed in front of the LCD unit 12, and mainly comprises a light source and a light guide (not illustrated in the diagram). The light source provides illumination from the side. The light guide is formed by the transparent material so that the supplemented illumination is distributed more uniformly. As indicated in the diagram, the light-detecting unit 11 is disposed on the spectacle frame and facing towards the lens for detecting the light intensity of the environment. That is, the light-detecting unit 11 detects the brightness status in front of the lens. The disposition position of the light-detecting unit 11 avoids the brightness generated by the active light source module 13 affecting the detection of the external light. In addition, the light-detecting unit 11 is formed by the photo-resistor or a photo-transistor.

Referring to FIG. 1(b), a functional block diagram of an image information display device 100 is shown. As indicated in the diagram, the image information display device 100 further comprises a processor 14, a display control unit 17, an operation interface 15 and a memory unit 16. These components or units may be disposed on the frame 10. FIG. 1(b) also illustrates the relationship of electrical connection between various function units. The processor 14 executes a light intensity determination procedure to correspondingly generate an automatic adjustment instruction for controlling the access and operation of other units. Besides, the processor 14 processes relevant to-be-displayed image information and the display control unit 17 controls the display of image on the LCD unit 12.

Next, the operation interface 15 provides the user with necessary operation control including whether to display the said image information, whether to operate the active light source module 13, the setting of the automatic adjustment procedure and the execution of the manual adjustment procedure. Similarly, the operation interface 15 can be directly disposed on the display device 100 or can provide operation control through a remote controller in a wireless manner. The said operation interface has the function of wireless signal transmission. Alternatively, a wireless signal transmission unit is disposed in the display device 100. The memory unit 16 stores relevant to-be-displayed image information and stores the data of the determination range of light intensity. The memory unit 16 also stores relevant operation program of the device as well as relevant detection value and the setting of manual adjustment generated after the user executes a manual adjustment procedure. Details of the implementation are disclosed below.

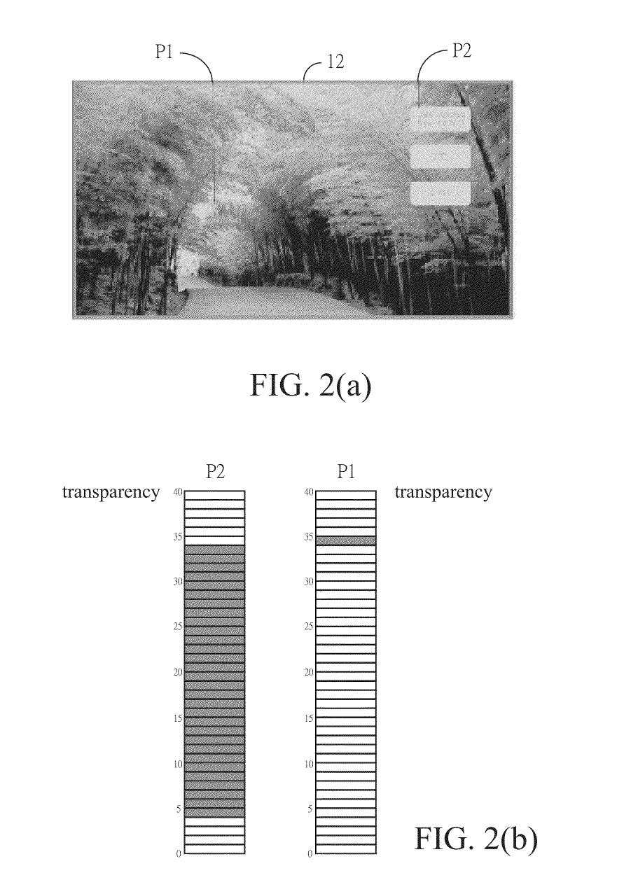

Referring to FIG. 2(a), a schematic diagram of an image displayed on the LCD unit 12 in an ordinary light intensity status is shown. FIG. 2(a) shows the result of one of the lenses of the design. The method for displaying and adjusting image information of the present invention is used in the display device 100. In the present embodiment, the method controls the LCD unit 12 to be transparent such that an environmental scene P1 is visible, and an image information P2 is displayed on the LCD unit 12 according to a display instruction. For example, the LCD unit 12 designed as a lens can be worn by the user and used in a mobile manner. Most part of the LCD unit 12 is transparent or transmissive. The environmental scene P1 is the front view of the lens or the user's vision. The image information P2 is a reminder with relevant text, pattern or symbol. The image information P2 only occupies a small portion of the display frame and overlaps the environmental scene P1. In the present embodiment, the display instruction may be generated from the operation interface 15 operated by the user or may be activated by the processor 14 according to the default setting of relevant programs.

As disclosed above, the lens of the image information display device 100 is formed by the liquid crystal panel. Therefore, the method for displaying and adjusting image information of the present invention, based on the transparency adjustment characteristics of the crystalline molecules of the liquid crystal panel, adjusts the transparency levels of the environmental scene P1 and the image information P2 respectively. According to the principles of the liquid crystal display, the rotation and arrangement of the crystalline molecules can be controlled by way of controlling the driving voltage applied on the crystalline molecules. The crystalline molecules in collocation with a polarizer further control the penetration of the light passing through the liquid crystal panel. The crystalline molecules and the polarizer control the display graduation of the image such as the bright/dark status and the black/white level of the displayed image. The display manner of controlling the volume of the light passing through the liquid crystal panel is similar to grey level display, and the contrast of the image can thus be adjusted.

Referring to FIG. 2(b), a schematic diagram of transparency levels of an environmental scene P1 and an image information P2 displayed on the LCD unit 12 in an ordinary light intensity status is shown. In the present embodiment, the adjustable range of transparency is exemplified by grades 0˜40 as indicated in the diagram, wherein 0 denotes null transmittance (completely impermeable to the light), and 40 denotes the highest transmittance. As indicated in the diagram, the image information P2 displayed on the LCD unit 12 may comprises texts or patterns in several colors, and the color depth of the image information P2 is displayed with a range (such as grades 5˜34) in terms of transparency control. As for the environmental scene P1 (that is, the transmissive region of the lens), to make the environmental scene P1 more clearly and uniformly displayed on the LCD unit 12, the transparency of the environmental scene P1 is controlled to be at a single higher grade (such as grade 35). In the present embodiment, as indicated in FIG. 2(b), the environmental scene P1 is not displayed with the highest transparency level in an ordinary light intensity status.

As disclosed above, the presentation of image information by the liquid crystal type image information display device will be affected by the ambient light. That is, the brighter the ambient light, the brighter the image information, and the darker the ambient light, the darker the image information. The ambient light being too bright is a nuisance to the user when watching the image information. Although the liquid crystal is not self-luminous, the image displayed by liquid crystal is visible to the user as long as sufficient light is available. When power-saving is taken into consideration, the timing for activating the active light source module 13 is an important factor to consider.

The first automatic adjustment procedure executed in a method for displaying and adjusting image information of the present invention at least includes steps of: detecting the light intensity of the environment by the light-detecting unit 11 to correspondingly generate a first detection value; comparing the first detection value with a determination range of light intensity by the processor 14 to correspondingly generate an automatic adjustment instruction according to the operation status of the active light source module 13; automatically adjusting the operation status of the active light source module 13 according to the automatic adjustment instruction to adjust the brightness of the image information P2 and correspondingly adjust the transparency of the LCD unit 12.

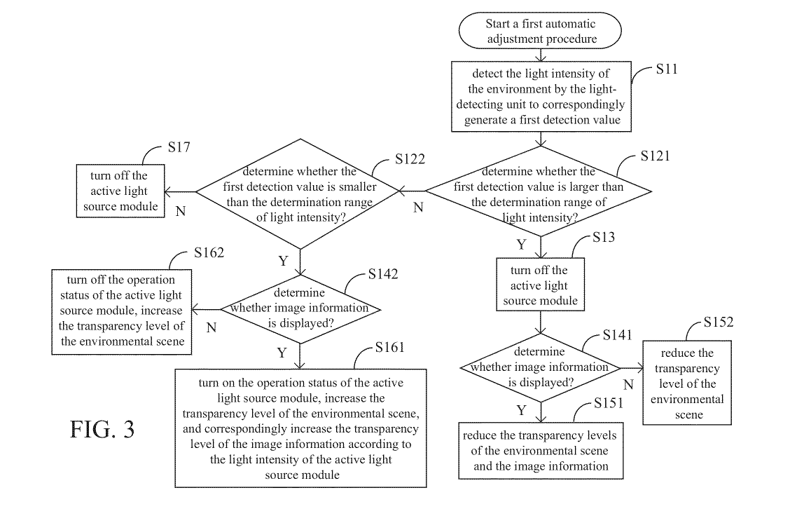

Referring to FIG. 3, a flowchart of a first automatic adjustment procedure of present invention is shown. Firstly, the light intensity of the environment is detected to correspondingly generate a first detection value (step S11). Next, the first detection value is compared with a determination range of light intensity by the processor 14 to determine whether the current environmental brightness denoted by the first detection value is brighter or darker (step S121, S122). In the present embodiment, the determination range of light intensity is predetermined. Based on the observation by the naked eyes, various ranges respectively denoting bright status, ordinary status, dark status and darker status are obtained from statistical data. The flowchart only illustrates the automatic adjustment instruction for brighter status, even darker status and ordinary status (step S13, S151˜S17), and further comprises the determination whether the image information P2 is displayed (step S141, S142) and corresponding implementation. Details of the status of the environmental brightness and its corresponding automatic adjustment procedure are disclosed below.

In terms of current technology, when the light passes through the LCD unit 12, the intensity of the light is relatively reduced, and the light-detecting unit 11 detects the light intensity of its front environment. To reduce the brightness change sensible to human eyes and to effectively determine the actual bright/dark status of the environment based on the determination range of light intensity, the following design is adopted. After the light intensity of the environment is detected, the possibly generated loss in the intensity of the light based on the internal design of the LCD unit 12 is reflected to actual results of detection. For example, a predetermined difference is deducted from the actual results of detection as a calibration for generating a corresponding first detection value. In the present embodiment, the first detection value generated by way of calibration is used for correct adjustment.

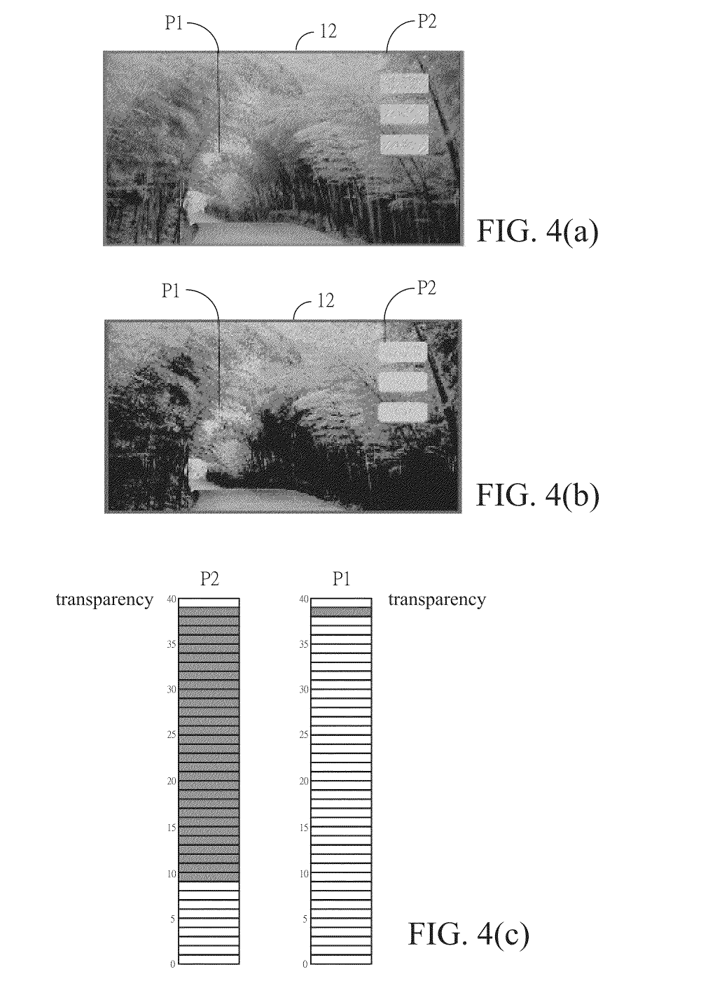

Referring to FIGS. 4(a)-(c). FIG. 4(a) shows a schematic diagram of an unadjusted image displayed on the LCD unit 12 when the light intensity of an ambient light is in a relatively darker status. FIG. 4(b) shows a schematic diagram of an adjusted image displayed on the LCD unit 12 when the light intensity of an ambient light is in a relatively darker status. FIG. 4(c) shows a schematic diagram of transparency levels of an adjusted environmental scene P1 and an adjusted image information P2 displayed on the LCD unit 12.

As disclosed above, in the present embodiment, whether the light intensity of the ambient light is brighter or darker is determined by comparing the first detection value denoting the current environmental brightness with the predetermined determination range of light intensity. In the status of FIG. 4(a), the first detection value denoting the current environmental brightness is smaller than the determination range of light intensity. Since the difference is not big (for example, the first detection value is smaller than the determination range of light intensity but the difference is within a predetermined difference), the ambient light is determined to be relatively darker. Therefore, in the current status, only transparency adjustment is required and there is no need to enhance the illumination of the active light source module 13. Therefore, the corresponding automatic adjustment procedure is: controlling the operation status of the active light source module 13 to be in an OFF status, and increasing the transparency levels of the environmental scene P1 and the image information P2 displayed on the LCD unit 12. As indicated in FIG. 4(c), the transparency level of the environmental scene P1 is adjusted to a higher grade (such as grade 39 relative to the ordinary status as indicated in FIG. 2(b)), and the transparency level of the image information P2 is adjusted to a range of higher grades (such as grades 10˜39). The results of adjustment are illustrated in FIG. 4(b).

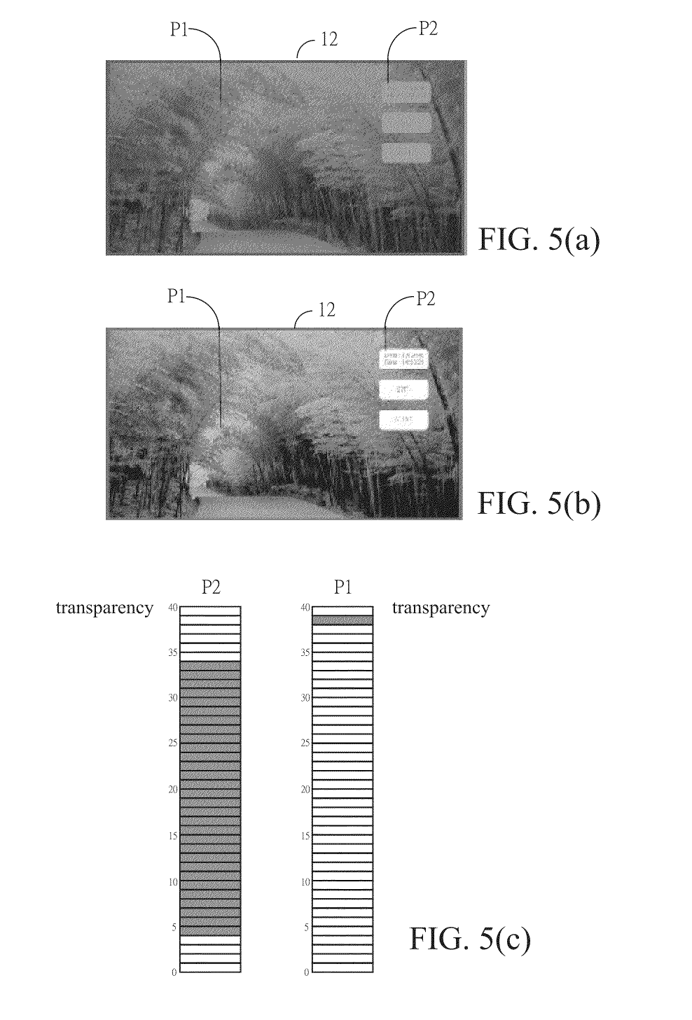

Referring to FIGS. 5(a)˜(c). FIG. 5(a) shows a schematic diagram of an unadjusted image displayed on the LCD unit 12 when the light intensity of an ambient light is in a relatively even darker status. FIG. 5(b) shows a schematic diagram of an adjusted image displayed on the LCD unit 12 when the light intensity of an ambient light is in a relatively even darker status. FIG. 5(c) shows a schematic diagram of transparency levels of an adjusted environmental scene P1 and an adjusted image information P2 displayed on the LCD unit 12.

As disclosed above, in the status of FIG. 5 (a), the first detection value denoting the current environmental brightness is smaller than the determination range of light intensity. Since the difference is big (for example, the first detection value is smaller than the determination range of light intensity but the difference has reached a predetermined difference), the ambient light is determined to be even darker. Therefore, in the current status, not only transparency adjustment is required but also the illumination of the active light source module 13 needs to be enhanced. Therefore, the corresponding automatic adjustment procedure is: controlling the operation status of the active light source module 13 to be in an ON status, and increasing the transparency level of the environmental scene P1 displayed on the LCD unit 12, and correspondingly increasing the transparency level of the image information P2 displayed on the LCD unit 12 according to the light intensity of the active light source module 13 (step S161 of FIG. 3). The light intensity of the active light source module 13 can be obtained from the manufacturing process. As indicated in FIG. 5 (c), the transparency level of the environmental scene P1 is adjusted to a higher grade (such as grade 39 relative to the ordinary status as indicated in FIG. 2(b)). Since the light source is enhanced, the transparency level of the image information P2 can be adjusted to a range of ordinary grades (such as grades 5˜34). The results of adjustment are illustrated in FIG. 5(b)

On the other hand, the image information P2 may further not be displayed on the LCD unit 12 according to a display stop instruction. In the present embodiment, the display stop instruction can be generated from the operation interface 15 operated by the user, or the processor 14 may turn off the display function of corresponding information according to the default setting of relevant programs. With respect to this status, under the circumstance that the image information P2 is not displayed, the transparency level is adjusted without enhancing the illumination of the active light source module 13 despite that the environment turns even darker (that is, the first detection value denoting the current environmental brightness is smaller than the determination range of light intensity but the difference has reached a predetermined difference). Therefore, the corresponding automatic adjustment procedure is: controlling the operation status of the active light source module 13 to be in an OFF status, and increasing the transparency level of the environmental scene P1 displayed on the LCD unit 12 (step S162 of FIG. 3), and the result is similar to FIG. 4(c) and FIG. 5 (c).

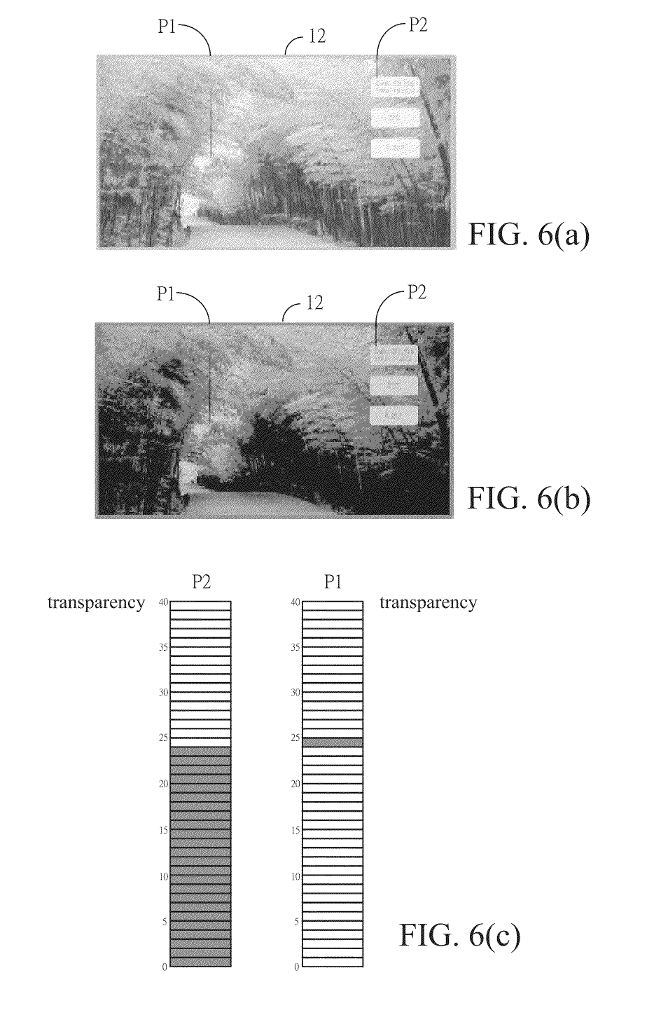

Referring to FIGS. 6(a)˜(c). FIG. 6(a) shows a schematic diagram of an unadjusted image displayed on the LCD unit 12 when the light intensity of an ambient light is in a relatively brighter status. FIG. 6(b) shows a schematic diagram of an adjusted image displayed on the LCD unit 12 when the light intensity of an ambient light is in a relatively brighter status. FIG. 6(c) shows a schematic diagram of transparency levels of an adjusted environmental scene P1 and an adjusted image information P2 displayed on the LCD unit 12.

As disclosed above, in the status of FIG. 6(a), the first detection value denoting the current environmental brightness is larger than the determination range of light intensity. Since the environment is brighter, there is no need to enhance the illumination of the active light source module 13 no matter whether the environmental brightness is too bright to the user's vision (for example, a small difference indicates a brighter status or a large difference indicates an even brighter status) or whether the image information P2 is displayed on the LCD unit 12 (step S13 of FIG. 3). This status only requires transparency adjustment. Therefore, the corresponding automatic adjustment procedure is: controlling the operation status of the active light source module 13 to be in an OFF status, and reducing the transparency levels of the environmental scene P1 and the image information P2 displayed on the LCD unit 12 (step S151 of FIG. 3). As indicated in FIG. 6(c), the transparency level of the environmental scene P1 is adjusted to a lower grade (such as grade 25 relative to the ordinary status as indicated in FIG. 2(b)), and the transparency level of the image information P2 is adjusted to a range of lower grades. In order to represent the color depth, the transparency level of the image information P2 needs to be adjusted to by the range. According to the design of the LCD unit 12, if the adjustable range of the transparency level only has limited grades, the room for downward adjustment may be insufficient. As indicated in FIG. 6(c), the adjustment range of color depth needs to be compressed (such as grades 0˜24) in order to complete the transparency adjustment of all colors. The results of adjustment are illustrated in FIG. 6(b).

Likewise, the image information P2 may also not be displayed on the LCD unit 12 according to a display stop instruction. With respect to this status, under the circumstance that the image information P2 is not displayed, the transparency level is adjusted without enhancing the illumination of the active light source module 13 despite that the environment turns brighter or even brighter (that is, the first detection value denoting the current environmental brightness is larger than the determination range of light intensity regardless of how big the difference is). Therefore, the corresponding automatic adjustment procedure is: controlling the operation status of the active light source module 13 to be in an OFF status, and reducing the transparency level of the environmental scene P1 displayed on the LCD unit 12 (step S152 of FIG. 3), and the result is similar to FIG. 6(c).

When the first detection value denoting the current environmental brightness is neither larger than nor smaller than the determination range of light intensity, this implies that the first detection value is within the determination range of light intensity. Relatively, the environmental brightness is neither brighter, nor darker or even darker, and is in an ordinary light intensity status. With respect to this status, the corresponding automatic adjustment procedure is: controlling the operation status of the active light source module 13 to be in an OFF status (for example, the environment may turn brighter from darker, and the previous operation status of the active light source module 13 is an ON status), and the above relevant automatic adjustment procedure needs to be repeated only when the bright/dark status of the environment varies and exceeds the predetermined determination range of light intensity (step S17 of FIG. 3).

In the first embodiment, the first automatic adjustment procedure is executed with the predetermined determination range of light intensity. That is, when the bright/dark status of the environment varies, the image information display device 100 of the present invention, automatically executes corresponding adjustment of transparency (that is, contrast) and brightness according to the first automatic adjustment procedure to provide comfortable visual conditions to the user no matter the user is watching the environmental scene or watching the image information. However, the determination range of light intensity is predetermined and stored in the memory unit 16 for the reference in determination. Although the content of determination range of light intensity may be obtained through the results of observation by human eyes, the results may not be conformed to the user's visual perception.

The method for displaying and adjusting image information of the present invention not only provides predetermined determination standards and corresponding automatic adjustment procedures, but also allows the user to execute manual adjustment based on the user's personal perception. Furthermore, the method further stores the user's settings of manual adjustment under various statuses as a contrast reference table. When the device of the present invention is used in different time but in the same status (the environmental brightness being the same), the user's previous setting of manual adjustment can be directly applied to execute suitable adjustment.

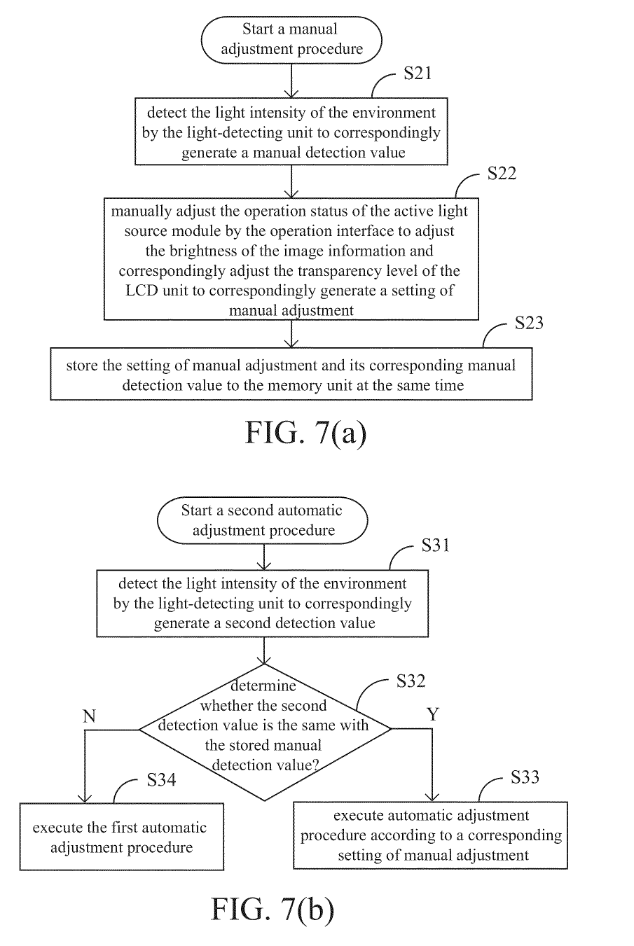

The present invention is further exemplified by a second embodiment below. The second embodiment still uses the image information display device 100 of the first embodiment except that at the beginning of the second embodiment, the user operates the operation interface 15 to execute a manual adjustment procedure. Referring to FIG. 7(a), a flowchart of a manual adjustment procedure of the present invention is shown. As indicated in the diagram, the manual adjustment procedure at least includes steps of: detecting the light intensity of the environment by the light-detecting unit 11 to correspondingly generate a manual detection value (step S21); manually adjusting the operation status of the active light source module 13 by the operation interface 15 to adjust the brightness of the image information P2 and correspondingly adjust the transparency level of the LCD unit 12 to correspondingly generate a setting of manual adjustment (step S22); storing the setting of manual adjustment and its corresponding manual detection value to the memory unit 16 at the same time (step S23).

As disclosed above, the said manual detection values are magnitudes of light intensity obtained under various statuses, and the said settings of manual adjustment are the content of adjustment completed by the user under various statuses. Various corresponding settings of manual adjustment and manual detection values stored in the memory unit 16 can be used as a reference setting for the user next time when the user operates the image information display device 100. In the present embodiment, the method for displaying and adjusting image information of the present invention mainly executes a second automatic adjustment procedure. The second automatic adjustment procedure automatically executes operations such as comparison, access and adjustment based on the settings stored by the user. If suitable adjustment settings or corresponding manual detection values cannot be found in the memory unit 16, then the first automatic adjustment procedure of the first embodiment is executed.

Referring to FIG. 7(b), a flowchart of a second automatic adjustment procedure of the present invention is shown. As indicated in the diagram, the second automatic adjustment procedure at least includes steps of: detecting the light intensity of the environment by the light-detecting unit 11 to correspondingly generate a second detection value (denoting the current brightness of the environment) (step S31); comparing the second detection value with the manual detection value by the processor 14 (that is, whether the second detection value is the same with the stored manual detection value is determined) (step S32); executing automatic adjustment according to a corresponding setting of manual adjustment when the second detection value and the manual detection value are the same (step S33); and, executing the first automatic adjustment procedure when the second detection value and the manual detection value are different from each other (step S34) (that is, steps S11˜S17 are executed).

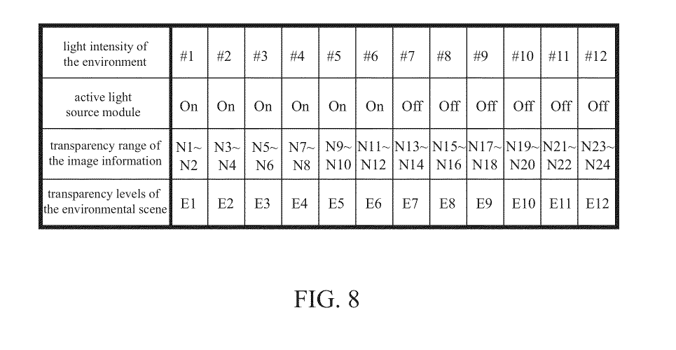

According to the disclosure of the second embodiment, the present invention effectively provides the user with manual adjustment for executing corresponding automatic adjustment procedure, the setting of manual adjustment under the same status can be directly applied to meet the user's operation requirements and visual perception without having to execute another manual adjustment procedure. The contrast reference table completed according to the manual adjustment procedure of the second embodiment is exemplified in FIG. 8. Larger numbering of light intensity denotes larger brightness.

The first and the second embodiment are exemplified by the liquid crystal type image information display device. The display unit that can be used for displaying information is not limited to the liquid crystal display unit. For example, the display panel or display unit formed by the organic light emitting diode (OLED) made from a transparent material can also be used as the lens of the image information display device for displaying relevant image information and maintaining transparency in the remaining region. The present invention is further exemplified by a third embodiment below. The third embodiment is different from the first and the second embodiment in that the image information display device uses an OLED display unit, but other operations, such as the detection and determination of the light intensity of ambient light as well as the viewing, application and operation of image information, remain the same.

In terms of current technology, the OLED display unit is self-luminous and does not require a backlight module. Unlike the LCD unit, the OLED display unit does not have the liquid crystal or the polarizer for controlling the penetration of the light. Although the display unit formed by the OLED made from a transparent material can be transparent and makes an environmental scene visible, such display unit cannot execute transparency adjustment with respect to the environmental scene and can only maintain a fixed transparency level. In other words, the OLED display unit can only execute brightness adjustment on the displayed image information through the intensity of the light emitted by the OLED display unit, so that the user can clearly view the displayed information under different statuses of environmental brightness.

The method for displaying and adjusting image information of the third embodiment of the present invention is used in an image information display device which comprises a light-detecting unit, an OLED display unit and a processor. The method at least includes steps of: controlling an OLED display unit to be transparent, so that an environmental scene is visible, and an image information is displayed on the OLED display unit according to a display instruction; detecting the light intensity of the environment by the light-detecting unit to correspondingly generate a detection value; comparing the detection value with a determination range of light intensity by the processor to correspondingly generate an automatic adjustment instruction; and automatically adjusting the brightness of the image information displayed on the OLED display unit according to the automatic adjustment instruction.

The automatic adjustment instruction of the present embodiment is for: reducing the brightness of the image information displayed on the OLED display unit when the detection value is larger than the determination range of light intensity or increasing the brightness of the image information displayed on the OLED display unit when the detection value is smaller than the determination range of light intensity. The magnitude by which the brightness is reduced or increased can be predetermined according to the difference between the detection value and the determination range of light intensity or according to the user's setting of manual adjustment as disclosed in the first and the second embodiment.

In terms of other possible embodiments, the design of the image information display device of the present invention can be realized in the architecture of glasses in addition to other forms of architecture such as a transparent showcase with information display function.

The appearance of the said showcase can be formed by the LCD or OLED display unit made from a transparent partitioning material, and the light-detecting unit can detect the light intensity inside the showcase, such that the image information or transmissive images displayed on the transparent partitioning material can be correspondingly adjusted under different statuses. That is, the transparency levels of the transmissive images and the image information can be adjusted according to the method disclosed in the first and the second embodiment, and the brightness of the image information can be enhanced, and the brightness of the displayed image information can be controlled according to the method disclosed in the third embodiment.

As disclosed above, since the showcase may need to provide a light source to enhance the brightness of the displayed products and the operation requirements of the light source may be different for daytime and nighttime operations, the light intensity in the showcase may vary accordingly. Therefore, when the image information display device of the present invention is designed according to the architecture of showcase and uses corresponding display and adjustment methods, the passengers outside the showcase can clearly see relevant image information of product introduction displayed on the transparent partitioning material.

To summarize, the device and the method for displaying and adjusting image information of the present invention effectively resolve the problem of viewing the image information displayed on a conventional display device formed by liquid crystal panel when the bright/dark status of the environment varies. Through the adjustment in transparency and the enhancement in the brightness of the active light source, the transmissive environmental scene and the displayed image information can be seen more clearly and visual discomfort can be avoided. Also, through the design of automatic adjustment procedure, the user has more flexibility in use and operation in movement is made safer, and the operation is more power saving. Moreover, the present invention further provides the design of user manual adjustment, such that the results of adjustment are more conformed to the users' needs. On the other hand, the present invention further adopts the use of OLED display unit and can thus provide partial similar results of adjustment achieved by the LCD unit. Therefore, the present invention effectively resolves relevant problems encountered in prior art, and successfully achieves main objects of the invention.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for displaying and adjusting image information, wherein the method is used in an image information display device which comprises a light-detecting unit, an LCD unit, an active light source module and a processor, and the method at least comprises steps of:
controlling an LCD unit to be transparent, so that an environmental scene is visible, and an image information is displayed on the LCD unit according to a display instruction;
executing a first automatic adjustment procedure, comprising steps of:
detecting the light intensity of the environment by the light-detecting unit to correspondingly generate a first detection value;
comparing the first detection value with a determination range of light intensity by the processor to correspondingly generate an automatic adjustment instruction according to the operation status of the active light source module; and
automatically adjusting the operation status of the active light source module according to the automatic adjustment instruction to adjust the brightness of the image information and correspondingly adjust the transparency of the LCD unit.

2. The method for displaying and adjusting image information according to claim 1, wherein the method at least comprises steps of:
controlling the operation status of the active light source module to be in an OFF status when the first detection value is larger than the determination range of light intensity; and
reducing the transparency levels of the environmental scene and the image information displayed on the LCD unit.

3. The method for displaying and adjusting image information according to claim 1, wherein the method at least comprises steps of:
stopping displaying the image information on the LCD unit according to a display stop instruction;
controlling the operation status of the active light source module to be in an OFF status when the first detection value is larger than the determination range of light intensity; and
reducing the transparency level of the environmental scene displayed on the LCD unit.

4. The method for displaying and adjusting image information according to claim 1, wherein the method at least comprises steps of:
controlling the operation status of the active light source module to be in an ON status when the first detection value is smaller than the determination range of light intensity; and
increasing the transparency level of the environmental scene displayed on the LCD unit and correspondingly increasing the transparency level of the image information displayed on the LCD unit according to the light intensity of the active light source module.

5. The method for displaying and adjusting image information according to claim 1, wherein the method at least comprises steps of:
stopping displaying the image information on the LCD unit according to a display stop instruction;
controlling the operation status of the active light source module to be in an OFF status when the first detection value is smaller than the determination range of light intensity; and
increasing the transparency level of the environmental scene displayed on the LCD unit.

6. The method for displaying and adjusting image information according to claim 1, wherein the method at least comprises steps of:
controlling the operation status of the active light source module to be in an OFF status when the first detection value is smaller than the determination range of light intensity; and
increasing the transparency levels of the environmental scene and the image information displayed on the LCD unit.

7. The method for displaying and adjusting image information according to claim 1, wherein the method at least comprises steps of: controlling the operation status of the active light source module to be in an OFF status when the first detection value is within the determination range of light intensity.

8. The method for displaying and adjusting image information according to claim 1, wherein the image information display device comprises an operation interface and a memory unit, and the method at least comprises steps of:
controlling the operation interface to execute a manual adjustment procedure, comprising steps of:
detecting the light intensity of the environment by the light-detecting unit to correspondingly generate a manual detection value;
manually adjusting the operation status of the active light source module by the operation interface to adjust the brightness of the image information and correspondingly adjust the transparency of the LCD unit to correspondingly generate a setting of manual adjustment; and
storing the setting of manual adjustment and its corresponding manual detection value to the memory unit.

9. The method for displaying and adjusting image information according to claim 8, wherein the method at least comprises steps of:
executing a second automatic adjustment procedure, comprising steps of:
detecting the light intensity of the environment by the light-detecting unit to correspondingly generate a second detection value;
comparing the second detection value with the manual detection value by the processor;
executing an automatic adjustment procedure according to a corresponding setting of manual adjustment when the second detection value and the manual detection value are the same; and
executing the first automatic adjustment procedure when the second detection value and the manual detection value are different from each other.

10. The method for displaying and adjusting image information according to claim 8, wherein the image information and the determination range of light intensity are stored in the memory unit.

11. An image information display device, comprising:
an LCD unit used for controlling to be transparent, so that an environmental scene is visible, and an image information is displayed on the LCD unit according to a display instruction;
a light-detecting unit used for detecting the light intensity of the environment to correspondingly generate a first detection value;
an active light source module used for providing a light source to correspondingly adjust the brightness of the image information;
a memory unit used for storing the image information and a determination range of light intensity; and
a processor used for comparing the first detection value with the determination range of light intensity to generate a corresponding automatic adjustment instruction according to the operation status of the active light source module, such that the active light source module automatically adjusts its operation status according to the automatic adjustment instruction, and the LCD unit automatically adjusts its transparency according to the automatic adjustment instruction.

12. The image information display device according to claim 11, wherein the image information display device comprises an operation interface, which provides operation for controlling the light-detecting unit to detect the light intensity of the environment to correspondingly generate a manual detection value, the operation interface further provides operations for manually adjusting the transparency of the LCD unit and adjusting the operation status of the active light source module to correspondingly generate a setting of manual adjustment, and the corresponding setting of manual adjustment and its corresponding manual detection value are both stored in the memory unit.

13. The image information display device according to claim 12, wherein the light-detecting unit is used for detecting the light intensity of the environment to correspondingly generate a second detection value, and the processor is used for comparing the second detection value with the manual detection value, the LCD unit and the active light source module execute automatic adjustment according to a corresponding setting of manual adjustment when the second detection value and the manual detection value are the same, and the LCD unit and the active light source module execute automatic adjustment procedure according to the automatic adjustment instruction when the second detection value and the manual detection value are different from each other.

14. A method for displaying and adjusting image information, wherein the method is used in an image information display device which comprises a light-detecting unit, an OLED display unit and a processor, and the method at least comprises steps of:
controlling an OLED display unit to be transparent, so that an environmental scene is visible, and an image information is displayed on the OLED display unit according to a display instruction;
detecting the light intensity of the environment by the light-detecting unit to correspondingly generate a detection value;
comparing the detection value with a determination range of light intensity by the processor to correspondingly generate an automatic adjustment instruction; and
automatically adjusting the brightness of the image information displayed on the OLED display unit according to the automatic adjustment instruction.

15. The method for displaying and adjusting image information according to claim 14, wherein the method at least comprises steps of: reducing the brightness of the image information displayed on the OLED display unit when the detection value is larger than the determination range of light intensity.

16. The method for displaying and adjusting image information according to claim 14, wherein the method at least comprises steps of: increasing the brightness of the image information displayed on the OLED display unit when the detection value is smaller than the determination range of light intensity.
